(19) United States
(12) Patent Application Publication
(10) Pub. No.: US 2002/0033967 A1
(43) Pub. Date: Mar. 21, 2002

(54) Apparatus and method for directly uploading scanned images to associated web sites

(76) Inventor: Cathy Liu, Hsinchu (TW)

Correspondence Address: BACON & THOMAS, PLLC, 4th Floor, 625 Slaters Lane, Alexandria, VA, 22314-1176, US

(21) Appl. No.: 09/808,054

(22) Filed: Mar. 15, 2001

(30) Foreign Application Priority Data
Sep. 16, 2000 (TW) 89119048

(51) Int. Cl. B41J 1/00; H04N 1/00

(52) U.S. Cl. 358/402

(57) ABSTRACT

An apparatus and method for directly making a computer system that couples with a scanner to connect with an associated web site and for further uploading scanned images by means of one touch action from the scanner is disclosed. Individual may give command in scanner side via one touch action to make the computer system coupled with the scanner to connect with associated web sites. Individual may upload derived scanned images to the connected web sites by means of one touch action in the scanner. Additionally, individual may assign web sites, or confirm/vary URLs of the web sites before uploading the scanned images.

### BACKGROUND OF THE INVENTION

1. Field of the Invention

The present invention relates to an apparatus and method for directing coupling with web sites via one touch action. More particularly, the present invention relates to an apparatus and method for directly making a computer system, which couples with a scanner, to couple with an assigned web site by means of one touch action from the scanner.

In a specific application, the present invention relates to an apparatus and method for directly uploading scanned images to an assigned web site by means of one touch action from the scanner.

2. Description of the Prior Art

Advancement in electrical engineering makes the functions and performance provided by computer peripheral devices to keep increasing exponentially. For example, engineers who are skilled in manufacturing scanners should unceasingly upgrade scan resolutions and color display performance. They should have to enable their products to activate printers to copy scanned images or to fax the scanned ones to destinations indicated by individual via computer systems. However, conventional scanners usually define a button as a unique function, such as enabling scanning, copying, or faxing operations in a scanner, individual may activate those functions by pressing associated buttons.

Conventionally, individual should turn on scanner power and make the scanner to successfully connect with a computer system before enabling associated scan operation by pressing pre-defined scan button in scanner or via graphic interfaces provided by the scanner manufacturers displayed in the screen of the computer system. Scanned images should be forwarded to the computer system via a connection, therefore individual may perform further operations such as optical character recognition, activating applications for editing the scanned images, or even activating a browser to upload the scanned images to web sites indicated by individual. Individual obviously has to perform a plurality of operating sequences before uploading scanned images to associated web sites for viewing or even downloading by unspecific persons. Those operating sequences, such as enabling a scanner for scanning a document sheet, forwarding the scanned images to a computer system, activating a computer browser, assigning a URL (Uniform resource locator) of a web site for receiving uploaded scanned images, may be consecutively performed before uploading. Additionally, a scanner manufacturer usually provides powerful operating interfaces for controlling various scanner operations. For those persons who are unfamiliar with computer systems, they usually confuse by those powerful interfaces and find no way to obtain entrances for enabling required operations. There is a need to disclose a more convenient operation way accompanied with friendly interfaces that the aforementioned disadvantages of the conventional approaches should be completely eliminated.

### SUMMARY OF THE INVENTION

The principal object of the present invention is the provision of an apparatus and method that makes a computer system to connect with assigned web sites by means of one touch action in a scanner which coupled with the computer system.

The other object of the invention is the provision of an apparatus and method that directly uploads scanned images to assigned web sites by means of one touch action in a scanner.

In one embodiment, a button of the scanner side, which is defined as activating a computer system coupled with the scanner to connect with associated web sites, is pressed, a connection status between the computer system and the Internet is then detected. If the connection is already established, a computer browser will be activated by the computer system to couple with the web sited assigned by individual. Additionally, if individual wants to upload scanned images to the web sites, he or she may enable graphic interfaces shown in the computer system to activate associated scan operation to the scanner, while the scanned images are then uploaded to the web sites directly. Individual obviously employs so-called one touch action in the scanner side to achieve the purpose of establishing the connection with the assigned web sites and then uploading scanned images.

In another embodiment, a connection status between a computer system and the Internet is detected when individual press a SCAN-TO-WEB button mounted in a scanner. When the connection is established, the scanned images of document sheets are derived and forwarded from the scanner to the computer system. A computer browser will be activated to connect with the assigned web sites for uploading scanned images by means of one touch action in the scanner side.

In the embodiment, a scan resident module is mounted in the computer system, which further includes a command interpretation module, a command-encoding module, a user interface resource module, a computer resource inquisition module, an Internet resource store and control module, and a connection status detection module. Command interpretation module stores programs operated by the processing device of the computer system to perform operations of interpreting commands input from the scanner or computer system. Command-encoding module stores programs operated by the processing device of the computer system to perform operations of encoding commands for further forwarding to the scanner to enable associated scan operation, or to transfer the scanned image to the computer system. User interface resource module stores resource codes associated with graphics or icons required by graphic interfaces provided for performed operations such as varying URLs of the assigned web sites. Computer resource inquisition module stores programs operated by the processing device of the computer system to perform an operation such as inquiring the currently mounted applications of the computer system. Internet resource store and control module stores codes associated with the web sites indicated by individual. Connection status detection module stores programs operated by the processing device of the computer system to perform the operation such as monitoring the connection status between the scanner and computer system. Associated operations will be performed when the processing device of the computer system operates the programs or codes provided by the aforementioned modules.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic diagram of the preferred embodiment according to the present invention;

FIG. 1B is an exemplary diagram for illustrating an input device of the scanner in the embodiment;

FIG. 2 is a configuration module of a scan resident module in the embodiment;

FIG. 3A is a diagram illustrating an exemplary graphic interface when individual enables associated scan operation in the embodiment;

FIG. 3B is a diagram illustrating an exemplary graphic interface when individual enables associated fax operation in the embodiment;

FIG. 3C is a diagram illustrating an exemplary graphic interface when individual enables a composite button for activating functions included inside in the embodiment; and

FIG. 4 is a flowchart for illustrating the operating sequences of the embodiment.

### DESCRIPTION OF THE PREFERRED EMBODIMENT

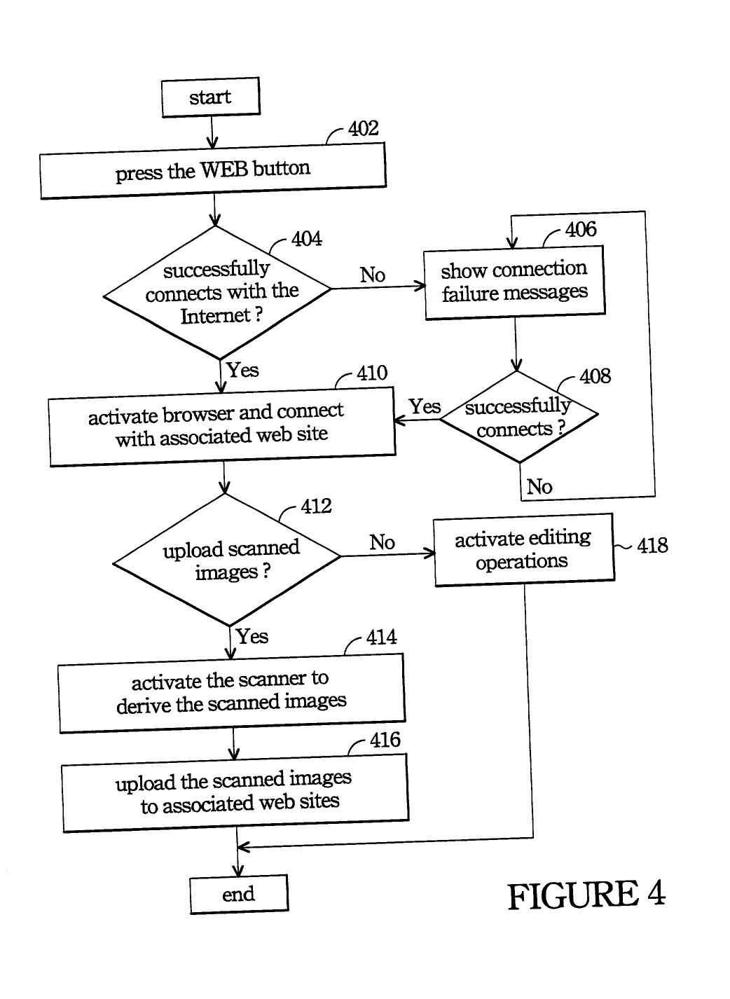

Please firstly refer to FIG. 4, a flowchart for illustrating operating sequences of the embodiment is shown therein. When individual presses a button for giving a command in a scanner (step 402), the given command will be routed to a computer system which is coupled with the scanner, while the computer system detects itself to connect with the Internet (step 404). If the connection is successfully established, the computer system will activate a computer browser to connect with web sites assigned by individual (step 410). Individual may further give an uploading command in the graphic interfaces shown in the computer system for uploading scanned images, and then the scanner may derive the scanned images by scanning document sheets (from steps 412 to 414). The computer system uploads the scanner images to the assigned web sites after the scanned images are forwarded from the scanner (step 416). Additionally, individual may perform editing operations to web pages after the computer system is successfully connected with associated web sites (from steps 412 to 418). Furthermore, if the computer system is not connected with the Internet in step 404, associated failure messages will be shown to notify individual to inquire for connection (step 406). Individual may give a command to make the computer system to connect with the Internet, while the operating flow will return to step 410 for activating the computer browser.

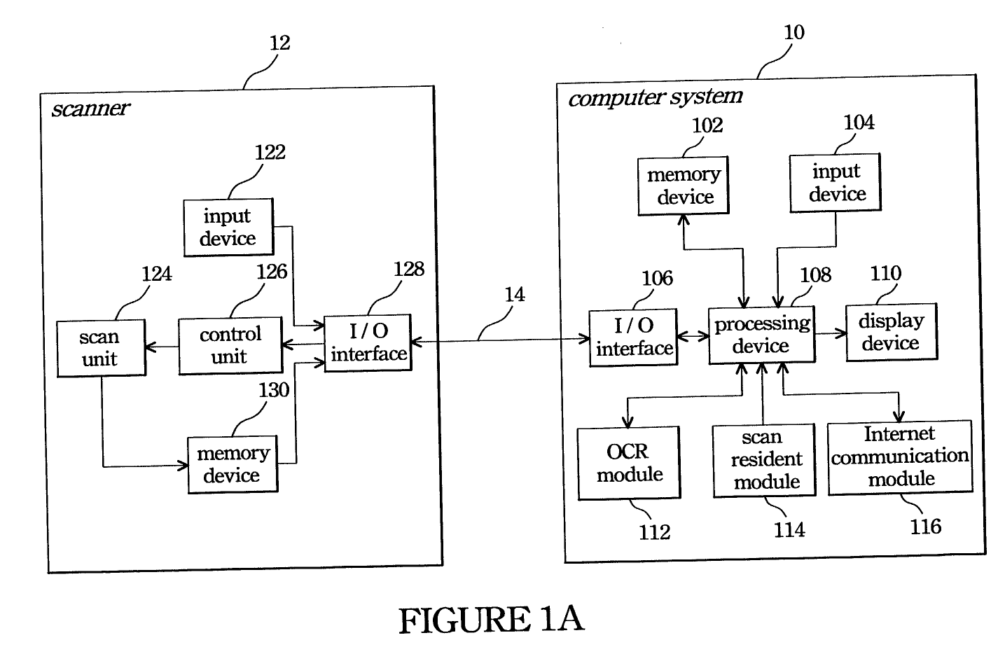

Notably, the scanner may activate the operations of uploading the scanned images and connecting with the assigned web sites by means of different buttons. Individual may press the defined button to upload the scanned images to associated web sites by following the flowchart of FIG. 4. Furthermore, at least two functions may be integrated in a composite button provided by the scanner, so that individual may press the composite button to enable graphic interfaces shown in the computer system to wait for further indications. For example, individual may determine to edit web pages or to upload scanned images via the graphic interfaces, however, a person skilled in the art of the invention should modify the arrangements of the aforementioned buttons for receiving commands from individual. Obviously, individual may give a command in the input device of the scanner to achieve the purpose of connecting with desire web sites, or even uploading the scanned images by means of so-called one touch action. Any mechanism or device that accomplishes the one touch action may be employed in the embodiment. Actually, the web site that receives the uploaded scanned images may be a web server that provides storage spaces for individual. For example, the manufacturer may provide her customers for specified storage spaces in her web site so that the customers may upload their scanned images for other customers for reference, viewing, or downloading. On the other hand, the preferred embodiment may further provide a graphic interface to notify individual to vary the URLs of the going-to-upload web sites. The aforementioned two approaches may be employed as applications but all similar modifications within the spirits of the embodiment should be included in the appended claims. Please now refer to FIG. 1A, a schematic diagram accompanied with user graphic interfaces for giving detailed descriptions to the preferred embodiment of the invention. The schematic diagram in FIG. 1A basically encompasses computer system 10 and scanner 12 that are coupled together via connection 14. Any wireless or wired communication approach or interface, including TWAIN, SCSI, EPP, or USB (Universal serial bus) may be employed as connection 14 in the embodiment. Please note that computer system 10 may be a personal computer (PC), a workstation, a notebook, or even a palm PC, while scanner 12 may be a roller feeding or flatbed scanner.

Computer system 10 in the embodiment basically encompasses memory device 102, input device 104, I/O interface 106, processing device 108, display device 110, OCR module 112, scan resident module 114, and Internet communication module 116. Processing device 108 couples with memory device 102, input device 104, I/O interface 106, display device 110, OCR module 112, scan resident module 114, and Internet communication module 116 to perform required operations of the computer system 10 in the embodiment. Input device 104 and display device 110 are both user interfaces that receives commands from individual and displays information by using optical signals, respectively. Memory device 102 stores information of computer system 10 that is provided for further manipulations by processing device 108. I/O interface 106 couples with scanner 12 for forwarding signals required by scanner 12 or for receiving signals input by individual from scanner 12 that the signals from scanner 12 are routed to processing device 108 for further processing. OCR module 112 stores programs operated by processing device 108 to perform the optical character recognition to the scanned images. Scan resident module 114 stores programs permanent stored in computer system 10 for detecting connection status between computer system 10 and scanner 12, interpreting commands from scanner 12, and real-time displaying interpretation results in display device 110 (more detailed explanations are given for scan resident module 114 later). Internet communication module 116 controls communications with the Internet such as inputting commands for inquiry information or web sites, or downloading/uploading information.

In the embodiment, scanner 12 basically encompasses input device 122, scan unit 124, control unit 126, I/O interface 128, and memory device 130. Input device 122 receives commands input by individual from scanner 12, while I/O interface 128 couples with I/O interface 106 of computer system 10 for transferring signals mutually. Scan unit 124 is responsive to the commands from control unit 126, while the generated scanned image is stored in memory device 130 before forwarding via I/O interface 128, connection 14 to computer system 10 to wait for manipulations by processing device 108.

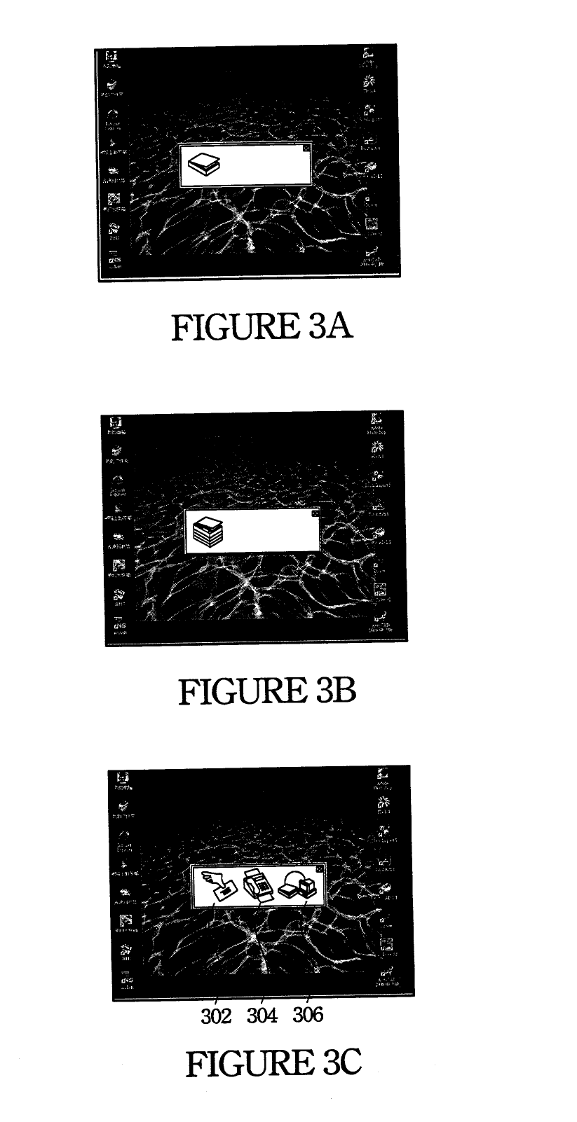

Input device 122 may be provided as interfaces for receiving commands by employing the configuration in FIG. 1B, which encompasses scan button (SCAN) 142, copy button (COPY) 144, composite button (FCN) 146, Internet communication button (WEB) 148, and button for scan and then activating associated applications (SCAN-TO-AP) 150. In operations, when individual presses SCAN button 142, the signals indicative of the pressing of SCAN button 142 will be routed to computer system 10 for manipulation. A graphic interface shown in FIG. 3A may be employed to notify individual for giving indications such as confirmations for associated scan parameters (e.g., scan resolution) while scanning, or enabling associated scan operation via the shown graphic interface. A confirmation command input via the graphic interface (may be input via the same button in scanner 12 by pressing it again) will be forwarded to scanner 12 for scanning document sheets. Additionally, when individual presses COPY button 144, the signals indicative of COPY button 144 being pressed will be routed to computer system 10 for manipulations so that a graphic interface in FIG. 3B may be shown to individual. The scanned images of the document sheets are then derived after a confirmation command for copying scanned document sheets being input from individual. Similarly, when individual presses WEB 148, the button pressed signals will be routed to computer system 10 for manipulations. Computer system 10 will connect with indicated web sites by following the flow of FIG. 4, while a graphic interface (not shown) may be shown to notify individual to perform consecutive operations such as editing web pages or uploading images deriving by scanner 12. Additionally, when individual presses FCN button 146, the button pressed signals will be routed to computer system 10 for manipulations. A graphic interface in FIG. 3C including graphic buttons 302, 304, and 306 respectively for activating functions of mailing (MAIL), faxing (FAX), and scanning and then loading by associated applications (SCAN-TO-AP) will be shown in display device 110 of computer system 10. Another invention with the same Applicant entitled “Apparatus and method for directly activating an application for editing information of an image after format conversion ” can be a cross-reference article of the invention for giving descriptions to SCAN-TO-AP button 150. However, another invention with the same Applicant entitled “Input apparatus and method of scanners having composite buttons for enabling functions” can be a cross-reference article of the invention for giving descriptions to FCN button 146.

As noted, the aforementioned input device 104 of the computer system 10 may be any kind of input interface, such as keyboard, mouse, or track ball, while input device 122 of scanner 12 may encompass at least one button or any mechanism for enabling so-called “one touch” action. Display device 110 may be a CRT or LCD system in the embodiment. Moreover, processing device 108 may be CPUs or microprocessors broadly employed in modern computer systems, while control unit 126 also can be mounted by means of microprocessors. Memory device 102 or 130 may be mounted by using DRAM, SRAM, or flash memory, etc, while OCR module 112, scan resident module 114, and Internet communication module 116 may be stored in computer-readable storage media such as hard disks. The aforementioned I/O interfaces 106 and 128 may be mounted according to practically employed interface for connection 14, while scan unit 124 may be any mechanism or device for scanning document sheets. An ordinary person skilled in the art of the invention may modify the embodiment as applications.

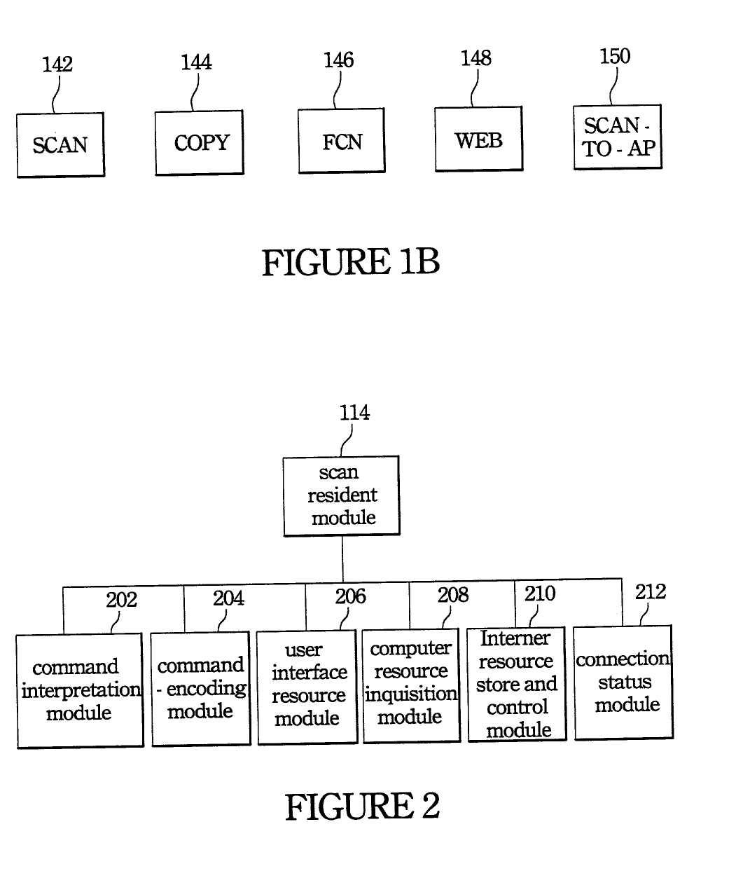

Please next refer to FIG. 2, a detailed configuration illustrative of scan resident module 114 is shown for giving more explanations. Basically, scan resident module 114 includes command interpretation module 202, command-encoding module 204, used interface resource module 206, computer resource inquisition module 208, Internet resource store and control module 210, and connection status detection module 212. Command interpretation module 202 stores programs provided for processing device 108 of computer system 10 to perform the operations of interpreting commands input from scanner 12 or computer system 10. Command-encoding module 204 stores programs provided for computer system 10 to perform operations of encoding commands in computer system 10 for further forwarding to scanner 12 to enable scan operation via connection 14, or to transfer the scanned image to computer system 10. User interface resource module 206 stores codes associated with graphics or icons required by the graphic interfaces shown in display device 110. Computer resource inquisition module 208 stores programs provided for computer system 10 to perform operations of inquiring currently mounted applications of computer system 10. Internet resource store and control module 210 stores codes associated with web sites indicated by individual. Connection status detection module 212 stores programs provided for computer system 10 to perform operations of monitoring the connection 14 between scanner 12 and computer system 10. Associated operations will be performed when processing device 108 of computer system 10 operates the programs or codes provided by the aforementioned modules. As noted, the aforementioned modules may be stored in any computer-readable and portable storage medium, e.g., a compact disc (CD), floppy disk, or magnetic optical (MO) disk, which is further accessed and operated by the processing device 108. However, the programs or codes of the above modules may be stored in hard disks of computer system 10 for performing associated operations while scanner 12 starting.

Furthermore, Internet resource store and control module 210 may store information codes associated with the assigned web sites including addresses of those web sites (e.g., uniform resource locator, URL) into a configuration file of scan resident module 114. Therefore computer system 10 may connect with the assigned web sites when individual presses WEB button 148. Additionally, Internet resource store and control module 210 may monitor uploading sequences of the scanned images. If computer system 10 does not connect with the Internet, Internet resource store and control module 210 may give individual a notification message indicative of whether the connection should be established or not. A graphic interface indicative of successful connection may be shown to notify individual for giving further indications, for example, giving a command to make the scanned images to be uploaded assigned web sites or editing web pages in the web sites. User interface resource module 206 may offer information associated graphic interfaces for individual when he or she varies URLs of the web sites. Additionally, command given for varying URLs may be interpreted by using command interpretation module 202 and then stored in a section “WEB” of the aforementioned configuration file. Please note that the above operations may be activated by means of composite button 146, however, individual may give commands in scanner 12 by means of one touch action. If FCN button 146 is employed, individual may give confirmation for uploading the scanned image in the graphic interface shown in computer system 10 (or terminate the graphic interface to edit web pages). An ordinary person who is skilled in the art associated with the invention may modify the embodiment as requirements but all the similar arrangements within the spirits of the embodiment should be included in the appended claims.

As is understood by a person skilled in the art, the foregoing preferred embodiments of the present invention are illustrated of the present invention rather than limiting of the present invention. It is intended to cover various modifications and similar arrangements, such as defining the function of directly uploading the scanned images in a composite or unique button, included within the spirit and scope of the appended claims, the scope of which should be accorded the broadest interpretation so as to encompass all such modifications and similar structure.

What is claimed is:

1. A scanner for making a computer system coupled with said scanner to couple with an assigned web site by means of one touch action, wherein said scanner comprises:
a scan unit for performing a scan operation to a document sheet to generate a scanned image; and
an input device responsive to a command input by employing said one touch action from said scanner to make said computer system to directly couple with said assigned web site via the Internet.

2. The scanner according to claim 1, wherein said input device comprises a button.

3. The scanner according to claim 1, wherein said computer system is responsive to said command to show a graphic interface for varying an address of said assigned web site.

4. The scanner according to claim 3, wherein said graphic interface comprises a composite input mechanism for activating a plurality of functions to said scanned image.

5. The scanner according to claim 1, wherein an address of said we b site is stored in a configuration file of a scan resident module associated with said scanner, wherein said scan resident module is mounted in said computer system.

6. The scanner according to claim 1, wherein said command makes said scanned image to be directly uploaded to said assigned web site via the Internet after said computer system coupled with said assigned web site.

7. A method for making a computer system coupled with a scanner to couple with an assigned web site by means of one touch action in said scanner, said method comprising the steps of:
inputting a command in said scanner by means of said one touch action;
forwarding said command to said computer system; and
activating said computer system to couple with said assigned web site via the Internet.

8. The method according to claim 7, further comprising a method for uploading a scanned image derived from said scanner by scanning a document sheet comprising the steps of:
generating said scanned image by said scanner when said computer system is successfully coupled with said assigned web site; and
uploading said scanned image to said assigned web site via the Internet.

9. The method according to claim 7, wherein said command is input from a button mounted in said scanner.

10. The method according to claim 7, further comprising a step of activating a graphic interface in said computer system for varying an address of said assigned web site after said command for uploading said scanned image is input from said scanner.

11. The method according to claim 10, wherein said graphic interface comprises a composite input mechanism for activating a plurality of functions to said scanned image.

12. The scanner according to claim 7, wherein an address of said assigned web site is stored in a configuration file of a scan resident module associated with said scanner, wherein said scan resident module is mounted in said computer system.

13. A computer system for directly coupling with an assigned web site according to a command input by means of one touch action from a scanner that is coupled with said computer system, wherein said computer system comprises:
a storage device;
a processing device coupled with said storage device for operating programs provided by said storage device to
perform said command; and
make said computer system to couple with said assigned web site;
wherein said command is input according to said one touch action in said scanner.

14. The computer system according to claim 13, wherein said storage device comprises:
a command interpretation module for storing programs operated by said processing device for interpreting said command input from said scanner or said computer;
a user interface resource module for storing resource codes of said graphic interfaces; and
an Internet resource store and control module for storing resource codes of said assigned web site to which said scanned image is uploaded.

15. The computer system according to claim 14, wherein said graphic interface comprises a composite input mechanism for activating a plurality of functions to said scanned image.

16. The computer system according to claim 14, wherein said user interface resource module comprises icon resource codes or graphic resource codes of a graphic interface provided for varying an address of said assigned web site after said command for uploading said scanned image is input from said scanner.

17. The computer system according to claim 13, wherein processing device operates said programs provided by said storage device to directly upload said scanned image to said assigned web site after said computer system is successfully coupled with said assigned web site.

18. The computer system according to claim 13, wherein said processing device operates said programs provided by said storage device to enable said scanner to generate said scanned image and forward said scanned image from said scanner to said computer system.
